(19) United States
(12) Patent Application Publication
(10) Pub. No.: US 2012/0090816 A1
(43) Pub. Date: Apr. 19, 2012

(54) SYSTEMS AND METHODS FOR HEAT TRANSFER UTILIZING HEAT EXCHANGERS WITH CARBON NANOTUBES

(75) Inventors: Yildiz Bayazitoglu, Houston, TX (US); Sukesh Shenoy, Houston, TX (US)

(73) Assignee: WILLIAM MARSH RICE UNIVERSITY, Houston, TX (US)

(21) Appl. No.: 13/272,627

(22) Filed: Oct. 13, 2011

Related U.S. Application Data
(60) Provisional application No. 61/392,568, filed on Oct. 13, 2010.
(60) Provisional application No. 61/515,398, filed on Aug. 5, 2011.

(51) Int. Cl. F28D 1/00; B23K 26/00; B21D 53/02

(52) U.S. Cl. 165/72; 29/890.03; 219/121.72; 165/185

(57) ABSTRACT

A heat exchanger with mini channels or micro channels provides enhanced heat transfer abilities. One or more surfaces of the channels may be covered with a nanostructure, such as single walled carbon nanotubes or multiwalled carbon nanotubes. The nanostructures may fully cover the entire surface of the channel or a selected surface area of the channel. Further, the nanostructures may be arranged into multiple patterned bundles covering the surface of the channel.

### RELATED APPLICATIONS

This application claims the benefit of U.S. Provisional Patent Application No. 61/392,568, filed on Oct. 13, 2010, and U.S. Provisional Patent Application No. 61/515,398, filed on Aug. 5, 2011, which are incorporated herein by reference.

### STATEMENT REGARDING FEDERALLY SPONSORED RESEARCH

This invention was made with government support under Grant No. HRD-0450363, awarded by the National Science Foundation. The government has certain rights in the invention.

### FIELD OF THE INVENTION

This invention relates to a heat exchanger. More particularly, the invention relates to a heat exchanger utilizing carbon nanotubes.

### BACKGROUND OF INVENTION

Heat exchangers are utilized to provide efficient heat transfer from one medium to another. For example, heat sinks may be utilized on electronic chips to transfer heat generated by the chip to air or another fluid by convection. Heat sinks may have a large surface area to provide efficient heat transfer. For example, heat sinks may utilize a variety of pin fin and/or other arrangements.

Next generation microchips with high power densities will likely require novel methods of cooling. Minichannels and microchannels provide an effective way of cooling microchips. High heat fluxes can be dissipated using forced convection in microchannels and minichannels. Microchannels provide enhanced heat transfer ability when compared to minichannels due to having a smaller hydraulic diameter however they come with increased pumping requirement. In addition, the fabrication of microchannels would require techniques that are time consuming and cost intensive. For example, fabrication of micro channels may include lithographic steps that consist of substrate preparation, photoresist coating, and stripping and etching. In the case of mini channels, the fabrication techniques are much simpler since the sizes involved are much larger. For example, fabrication can be done using conventional techniques like laser cutting. As such, mini channels can be manufactured more cost effectively and in less time than micro channels. Several methods of altering the microchannels surfaces including rectangular grooves, offset fins and longitudinal fins have been investigated. While these methods increase heat transfer, due to increased surface area, better flow mixing, and an increased heat transfer coefficient, they also had the disadvantage of added pressure drop. Therefore, there is a continuing need for heat exchangers with increased heat transfer capabilities. Systems and methods for heat transfer utilizing heat exchangers with surfaces including carbon nanotubes are discussed herein.

### SUMMARY OF THE INVENTION

In one implementation, a heat exchanger comprises a heat spreader providing at least one channel. A cover plate is secured to the heat spreader, and the cover plate encloses the channel. A plurality of vertically aligned nanostructures are created on at least one channel surface. The nanostructures may fully cover the channel or may be arranged into bundles on the channel.

In another implementation, a heat exchanger comprises a heat spreader providing a plurality of fins, wherein the fins dissipate heat absorbed by the heat spreader. A cover plate is secured to the heat spreader, and the fins and cover plate define at least one channel provided for fluid flow. An inlet provides entry into the channel, and an outlet provides exit from the channel. A plurality of vertically aligned nanostructures are created on at least one channel surface.

In another implementation, a method for fabricating a heat exchanger includes forming a plurality of nanostructures on a substrate, wherein the plurality of nanostructures are vertically aligned on the substrate. One or more openings are formed in a channel layer, wherein said one or more openings in the channel layer are formed by laser cutting. The channel layer is secured to the substrate, wherein the openings in the channel layer are aligned with the nanostructures on the substrate, and a top layer is secured to the channel layer, wherein the top layer, channel layer, and substrate define at least one channel containing the nanostructures.

In another implementation, a method for exchanging heat with a heat exchanger includes the steps of positioning a heat exchanger on an electronic device, and inputting a fluid into the heat exchanger through the inlet, wherein the fluid remains in a liquid phase when passing through the channel.

The nanostructures may cover entire portions of one or more channel surfaces, or the nanostructure may be arranged into bundles providing a desired pattern. Further, a working fluid, such as water, a nanofluid, or a dielectric fluid, passes through the channels to aid heat transfer.

The foregoing has outlined rather broadly various features of the present disclosure in order that the detailed description that follows may be better understood. Additional features and advantages of the disclosure will be described hereinafter.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIG. 1 is an illustrative implementation of a heat exchanger;

FIGS. 2a-2e provide illustrative implementations of various arrangements of CNTs on the surface of a heat exchanger;

FIGS. 3a-3e provide various illustrative implementations of fin geometries for a heat exchanger;

FIG. 4 provides an illustration of fabrication steps for a heat exchanger with CNTs;

FIGS. 5a and 5b provide SEM images of MWNTs and MWNT bundles arranged in cylindrical columns;

FIGS. 6a-6c provide Raman spectra of the MWNTs before laser cutting, after cutting, and between MWNT bundles;

FIG. 7 shows flow loop for experimental testing of the heat transfer characteristics;

FIGS. 8a and 8b show a test fixture and a heat exchanger for testing;

FIGS. 9a and 9b show a flow loop testing arrangement;

FIGS. 10a and 10b provide illustrative implementations of a computational model of a hexagonal mini channel and a copper block abutting the mini channel;

FIG. 11 shows the values of the measured pressure drop and the predicted measure drop for single phase in the three heat exchangers;

FIGS. 12a and 12b show experimental and modeling results of heat flux applied to the base a different silicon base temperatures;

FIG. 13 shows the minimum heat fluxes for the different devices beyond which visible boiling starts to occur; and

FIGS. 14a and 14b show the measured and predicted water temperature rise using the energy balance equation.

### DETAILED DESCRIPTION

Refer now to the drawings wherein depicted elements are not necessarily shown to scale and wherein like or similar elements are designated by the same reference numeral through the several views.

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

In order to improve heat transfer, a thermal management device utilizing heat exchangers with carbon nanotubes (CNTs) structured surfaces are proposed. Heat exchangers may be place on a microchip and utilized to dissipate undesirable heat from the microchip. A micro or mini channel heat exchangers may include finned surfaces that provide micro or mini channels for fluid to flow through. The fluid flow through the micro or mini channels provides convective heat transfer. Micro or mini channel heat exchangers increase heat transfer by providing a larger surface areas for convective heat transfer. In order to further increase heat transfer, one or more surfaces of the micro or mini channel heat exchangers may include CNTs.

Note that single walled carbon nanotubes (SWNTs), multiwalled carbon nanotubes (MWNTs), nanowires, and any other suitable nanostructures may be utilized on one or more surfaces of the heat exchanger. Further, the nanostructures are not limited to carbon materials, and may include carbon based materials (such as graphene), metals (such as copper, aluminum, and silver), composites mixtures of metals with different carbon based materials, any other suitable materials, or a combination thereof. The surfaces structures may be provided on any suitable surface, such as silicon, aluminum, copper, metal, and the like.

While exemplary implementations are discussed herein, it is noted that these implementations are merely illustrative and the scope of the invention is not limited to the exemplary implementations discussed. For example, the heat exchanger is not limited to the arrangements discussed herein and may utilize a variety of arrangements, such as cylindrical pin fins, oval-shaped pin fins, square-shaped pin fins, rectangular-shaped pin fins, straight fins, tubular fins, other structures, and/or combinations, thereof. Further, CNTs provided on the surfaces of the heat exchanger may be arranged to cover the entire surface, into patterned bundles, and/or any other suitable arrangement.

Various fluids may also be used in conjunction with the heat exchangers. Working fluids for liquid cooling in mini and/or micro heat exchanger have predominantly been water. In addition to the single phase heat transfer techniques, flow boiling may also be utilized. Two phase flows provide high heat transfer coefficients when compared to single phase flows and are suited for high heat flux dissipation. Nanofluids with water as the base fluid with various added nanoparticles offer several advantages for cooling. The thermal properties for these fluids can be tailored to suit the cooling requirements. Heat transfer has been carried out using CuO, Al₂O₃, TiO₂ and Cu based nanofluids. However, nanofluids come with certain drawbacks like sedimentation, clogging of channels, erosion and increased pressure drop. Dielectric fluids as the working fluid may also be an option. Dielectric fluids with their low boiling point and increased wetting properties provide an excellent way for increased heat transfer. However, dielectric fluids may have dry out and reverse flow problems.

Prior attempts to use CNTs as thermal interface materials in micro channels for cooling have had limited success. Flow boiling analysis with CNT coating in micro channels and water as the cooling medium has been reported to be effective as a result of an enhancement of critical heat flux resulting from the fact that the CNT coating in micro channels provide numerous nucleation sites. Single phase cooling using CNTs with water as cooling medium on the other hand was researched by Mo et al. “Integrated nanotube microcooler for microelectronics applications,” Proceedings of the IEEE Electronics Components and Technology Conference, IEEE, Laker Buena Vista, Fla. 2005, pp. 51-54. They applied different heat rates to the base of the silicon micro channel while holding the pressure drop across the device constant. This was then compared to a silicon micro channel with no CNTs. They observed in the case of silicon micro channels with CNT fins, that they could apply 23% higher input power and still keep the temperature of the transistor lower than a silicon micro channel with no CNTs.

However, studies on heat transfer using CNTs with water as the working fluid in single phase have not resulted in heat transfer enhancement. Research conducted on SWNTs in silicon microchannels and forced convection with water over the SWNTs at different heat fluxes and flow rates have showed that SWNTs result in no increase in heat dissipation. Rather, the SWNTs resulted in an add a thermal resistance, which the authors attributed to the hydrophobic nature of the CNTs. See C. R. Dietz and Y. K. Joshi, “Single-phase forced convection in microchannels with carbon nanotubes for electronics cooling applications,” Nanoscale and Microscale Thermophysical Engineering, 12 (3) (2008) 251-271.

For the invention discussed herein, research was conducted for mini channels with nanostructure provided on the channel surfaces to presented experimental results ranging from the single phase to the nucleation phase in the flow boiling regime. A comparison of the experimental results to the computationally modeled results was done and observed differences are explained herein. In general, it was unexpectedly found that the presence of CNTs resulted in enhanced heat removal from a silicon mini channel.

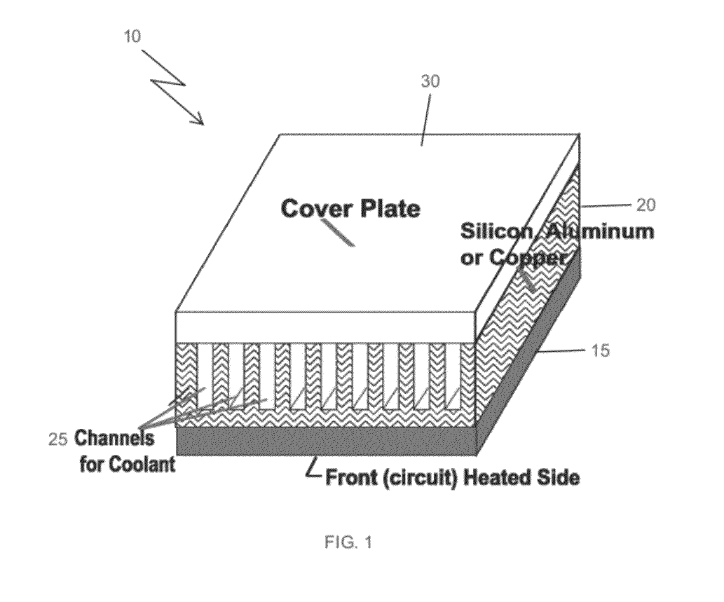

FIG. 1 is an illustrative implementation of a heat exchanger 10. Heat exchanger 10 may be place on a heat source 15 to dissipate heat from the heat source. Heat exchanger 10 may utilize a heat spreader 20 utilizing a fin arrangement to increase the surface area, thereby increasing convection. The straight fin arrangement shown provides channels 25 for fluid flow. However, in other implementations, heat spreader 20 may utilize cylindrical pin fins, oval-shaped pin fins, square-shaped pin fins, rectangular-shaped pin fins, straight fins, tube-shaped fins, or any other suitable arrangement utilized in heat exchangers.

Optionally, heat exchanger 10 may be covered by a plate 30. For instance, if the fluid flowing through channels 25 is a liquid, it may be desirable to utilize plate 30 to contain the liquid and direct the liquid in a desired direction. Heat spreader 20 and plate 30 define the dimensions of channels 25. When plate 30 is properly secured to heat spreader 20, such as by bonding or the like, fluid flow is directed through channel 25 as desired and does not escape into undesired areas. In some implementations, channels 25 may be mini or micro channels. In a mini channel the hydraulic diameter ranges from 3 mm to 200 micrometers. In a micro channel, the hydraulic diameter is typically below 200 micrometers. The hydraulic diameter D_{H}=4 A/P, where A is the cross sectional area and P is the wetted perimeter. Micro channels provide enhanced heat transfer ability when compared to mini channels. However, micro channels may have disadvantages, such as increased pumping requirements, time consuming and cost intensive fabrication, and/or added pressure drops.

In order to enhance the heat transfer capabilities of heat exchanger 10, one or more of the surfaces of channels 25 are covered with CNTs. The CNTs may be arranged vertically, such as in a nanotube carpet arrangement. In some implementations, the CNTs may be single walled carbon nanotubes or multiwalled carbon nanotubes. In other implementations, the CNTs may be substituted with nanowires, fullerenes, or other nanostructure. In some implementations, a desired section or portion of channels 25 may be fully covered by CNTs. In other implementations, the surfaces of channels 25 may be partially covered with CNTs in a desired arrangement or pattern.

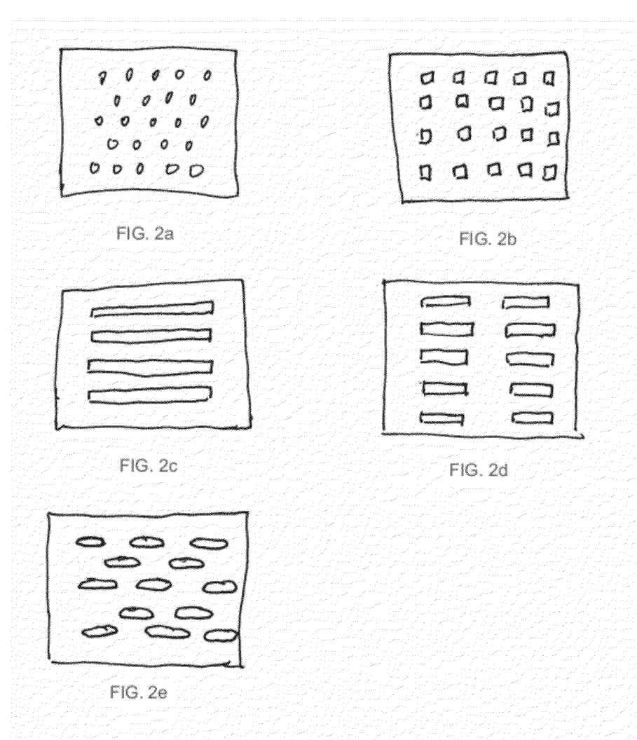

FIGS. 2a-2e provide various illustrative implementations of surface arrangements of CNTs on a heat exchanger. The CNTs provided on the surfaces of mini or micro channels may be arranged in various manners. For example, the CNTs may be arranged into several circular bundles of CNTs (FIG. 2a) or into pin fins on the surfaces of the channels. In other implementations, the CNTs may be arranged into square bundles (FIG. 2b), rectangular bundles (FIGS. 2c and 2d), oval bundles (FIG. 2e), or other arrangements. The CNT bundles may be aligned into ordered rows and columns, offset rows or columns, randomly, or any other suitable arrangement.

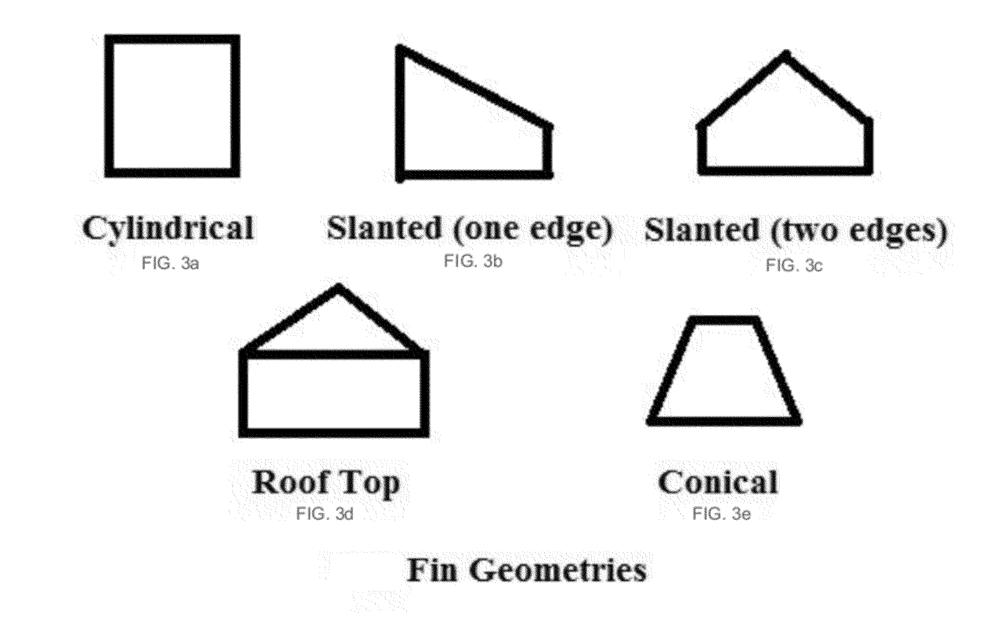

FIGS. 3a-3e provide various illustrative implementations of fin geometries for a heat exchanger. For example, the fin geometry of a heat exchanger may be cylindrical (FIG. 3a), one edge slanted (FIG. 3b), two edge slanted (FIG. 3c), roof top (FIG. 3d), conical (FIG. 3e), or the like. While various implementations of surface arrangements and fin geometries are discussed above, the invention is in no way limited to the particular implementations discussed.

### EXPERIMENTAL EXAMPLES

Additional details about experimental aspects of the above-described studies are discussed below.

Nomenclature

| | |
|---|---|
| A | surface area available for heat transfer |
| cₚ | specific heat at constant pressure |
| L | length of tubing (norprene, manifold) |
| Dₕₘ | hydraulic diameter of manifold |
| Dₕₙ | hydraulic diameter of norprene tubing |
| f | friction factor |
| k | thermal conductivity of copper block |
| k_{c} | contraction loss coefficient |
| kₑ | expansion loss coefficient |
| ΔP | total pressure drop |
| ΔP_{c} | pressure drop due to contraction |
| ΔP_{ch} | pressure drop across minichannel |
| ΔPₑ | pressure drop due to expansion |
| ΔPₘ | pressure drop through inlet and |
| | outlet manifold |
| ΔPₙ | pressured drop through norprene tubing |
| q | heat flux |
| Q | heat supplied |
| ΔT | temperature difference between |
| | thermocouples |
| Tᵢₙ | fluid inlet temperature |
| Tₒᵤₜ | fluid outlet temperature |
| T_{w} | base temperature |
| T_{b} | bulk fluid temperature |
| uₘ | fluid velocity through manifold |
| uₙ | fluid velocity through norprene |
| | tubing |
| v | volumetric flow rate |
| Δx | distance between thermocouples |
| | in the copper block |

Greek Symbols

| | |
|---|---|
| ρ | density |

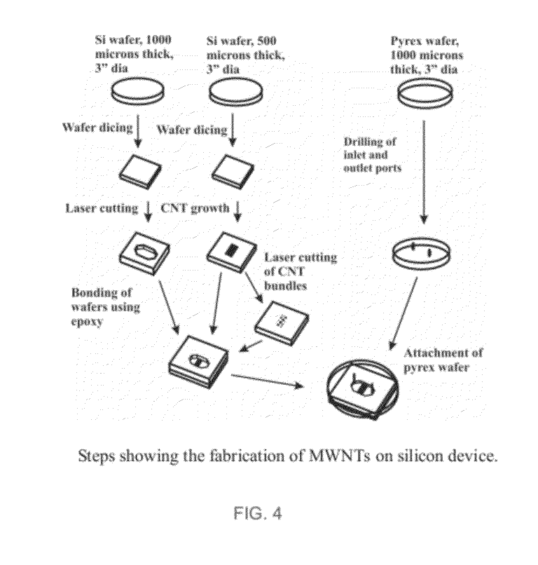

In order to test the heat transfer capabilities of heat exchangers utilizing CNTs, three different devices were fabricated—one with no MWNTs, one with fully covered MWNTs and one with a 6×12 array (6 rows and 12 columns) of MWNT bundles. FIG. 4 shows the basic steps involved in fabricating experimental heat exchangers. A 1 mm thick silicon wafer (pre-coated with 500 nm silicon dioxide) was diced into a 55 mm×45 mm rectangular piece. An octagonal hole was laser cut in the center of this piece to for the desired channel dimensions. This wafer piece was then bonded onto a 500 microns thick rectangular silicon wafer of similar dimensions. The widest and longest part of the channel is 25 mm and 35 mm, respectively. To form the cover plate for the channel, a 1 mm thick Pyrex wafer was drilled with two holes for inlet and outlet of water. The holes are drilled at a distance of 31 mm from each other. Capillary tubing of 1 mm inner diameter was used then to form the inlet and outlet manifolds. The Pyrex wafer was then bonded on top of the silicon wafer assembly using epoxy. This formed the base version i.e. the device with no MWNTs.

For the fully covered MWNT device and the 6×12 MWNTs heat exchangers, the fabrication steps were similar. The MWNTs were grown using chemical vapor deposition at 775° C. with a ferrocene catalyst and a xylene source with a mixture of argon and hydrogen as the carrier gas. In the case of the fully covered MWNT heat exchanger, the 500 microns thick Si wafer had a rectangular area of 24 mm×15 mm covered with MWNTs that was 500 microns in height in the center of the wafer. The 6×12 MWNT bundles were formed by laser cutting a fully covered MWNTs area.

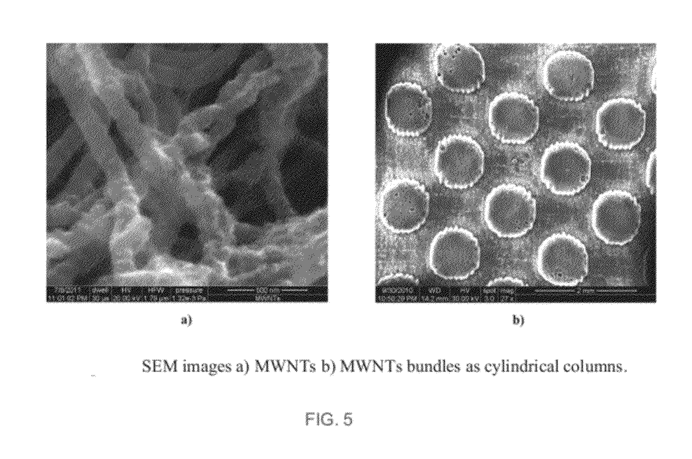

FIGS. 5a and 5b provide SEM images of MWNTs and MWNT bundles arranged in cylindrical columns on the wafer. In particular, FIG. 5a shows a dense entangled network of tubes with a broad diameter distribution of 10-100 nm. FIG. 5b shows a section of these bundles that are staggered in nature with a diameter of 1 mm and a height of 500 microns.

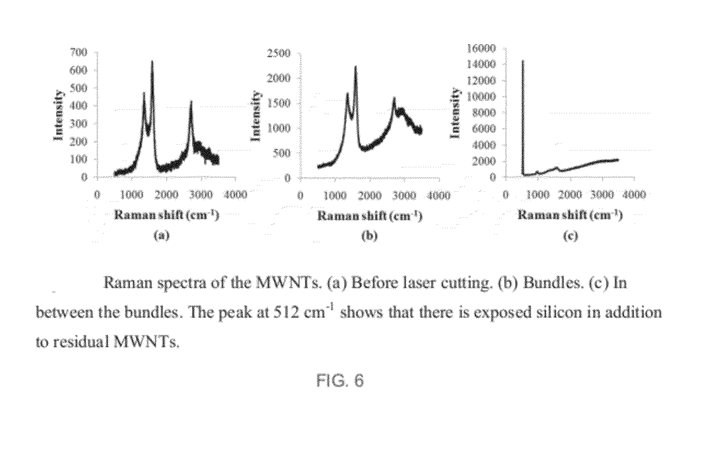

FIGS. 6a-6c provide Raman spectra of the MWNTs before laser cutting, after cutting, and between MWNT bundles. Raman spectroscopy of the 6×12 MWNTs device was done before and after laser cutting. It was observed that the characteristic Raman spectrum of MWNTs remains the same i.e. the MWNTs remained intact. In between the bundles, a peak at 512 cm⁻¹ was observed, which is the characteristic silicon peak, in addition to the characteristic MWNT peaks. It is believed that in between the bundles there were regions where the silicon was exposed in addition to some residual MWNTs. The as grown MWNTs were hydrophobic in nature, but it was observed that the wetting properties of MWNTs changed towards hydrophilic once the fins were submerged in water over time.

As discussed previously, the three different devices that were tested include (i) a silicon mini channel with no MWNTs, (ii) a silicon mini channel with fully covered MWNTs, and (iii) a silicon mini channel with MWNT pin fins. These devices were tested at different volumetric flow rates and different heat flux rates applied to the silicon channel base.

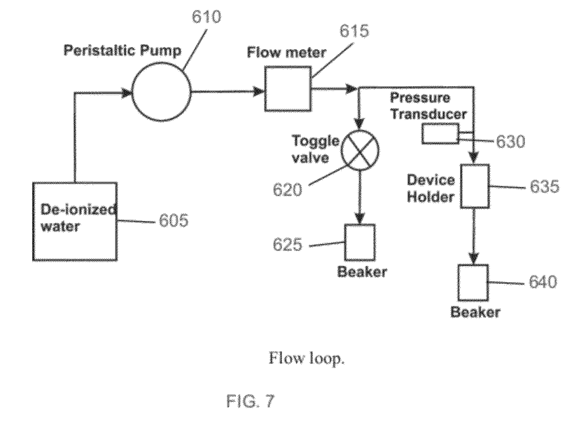

An experimental setup was used to test the devices included a flow loop and heating circuit. FIG. 7 shows a flow loop for experimental testing of heat transfer characteristics. De-ionized water 605 is pumped through the setup using pump 610, such as a peristaltic pump. Pump 610 may include a pump head and a drive to control the flow rate. Flow meter 615, such as a rotameter flow meter, is used to measure the volumetric flow rate of the water. The water then passes through test fixture 635, which is used to hold the devices to be tested, and the water is finally collected in beaker 640. Pressure transducer 630 is utilized to measure the pressure drop across a heat exchanger being tested in test fixture 635. Toggle valve 620 and beaker 625 are provided to take care of unintended pressure build up in the flow loop due to obstructions.

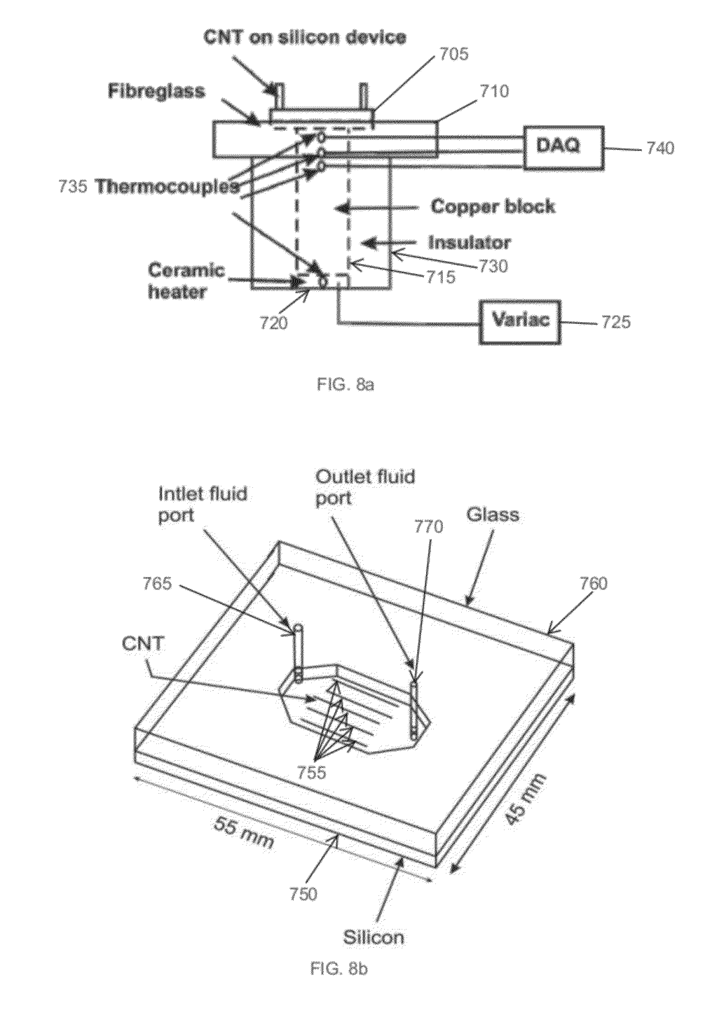

FIG. 8a shows a test fixture for experimental testing of heat transfer characteristics. A heat exchanger 705 to be tested is held in the device holder 710 made of fiberglass. The fiberglass has a 55 mm×45 mm rectangular recess and in the middle of the recess is a 25 mm×15 mm rectangular slot that houses copper block 715. Ceramic heater 720 that is controlled by a variable autotransformer or variac 725 heats copper block 715 that in turn heats the back surface of the heat exchanger 705 to be tested. Insulation 730 is used around the copper block to prevent heat loss. A thin layer of thermal interface material is applied to achieve good thermal contact between the copper block and the silicon surface. In addition, mechanical clamping can also be used to achieve a good thermal contact. Three holes drilled into the copper block are used to house thermocouples 735, such as 30 gauge type T thermocouples. Thermocouples 735 were anchored to copper block 715 using a thermal epoxy. Thermocouples 735 are used to measure the heat flux applied to the devices using Fourier's law.

$$q = k \frac{Δ T}{Δ x} \qquad ( 1 )$$

where Δx is the distance between the thermocouples, ΔT is the difference between the thermocouple temperatures and k is the thermal conductivity of the copper block. The top most thermocouple that is just below the silicon bottom surface is assumed to give the silicon surface temperature. Heater 720 may include an inbuilt thermocouple that provides a method to monitor the heater temperature. The data from the thermocouples is recorded using a data acquisition unit 740. Pressure drop across the device was measured using a differential pressure transducer. Since this is an open loop system, only one port of the transducer was connected to the inlet of heat exchanger 705. Since the outlet of the water was at atmospheric pressure, the pressure transducer provides the differential pressure.

FIG. 8b shows a heat exchanger for experimental testing of heat transfer characteristics. The heat exchanger may provide first layer 750, such as a silicon layer, coated with CNTs 755. First layer 750 may be bonded to a second layer 760, such as a glass layer, with an opening defining a channel. Inlet port 765 provides a pathway for fluid flow through second layer 760 to the channel with CNTs 755 provided on the surface of the channel. Outlet port 770 allows fluid to flow out of the heat exchanger. For testing purposes, inlet port 765 and outlet port 770 may include thermocouples for measuring inlet temperature and outlet temperature.

During experimental testing, the back surface of the heat exchanger was heated gradually in steps and readings from the three thermocouples and the outlet water temperature were noted after the temperature readings had reached steady state. The heat carried away by the water was calculated using the difference in the water inlet and outlet temperatures. The silicon base temperature versus the heat carried away by the water for the same fluid velocity was used to determine the heat removal characteristics of the two silicon mini channels with MWNTs compared to the silicon mini channel with no MWNTs.

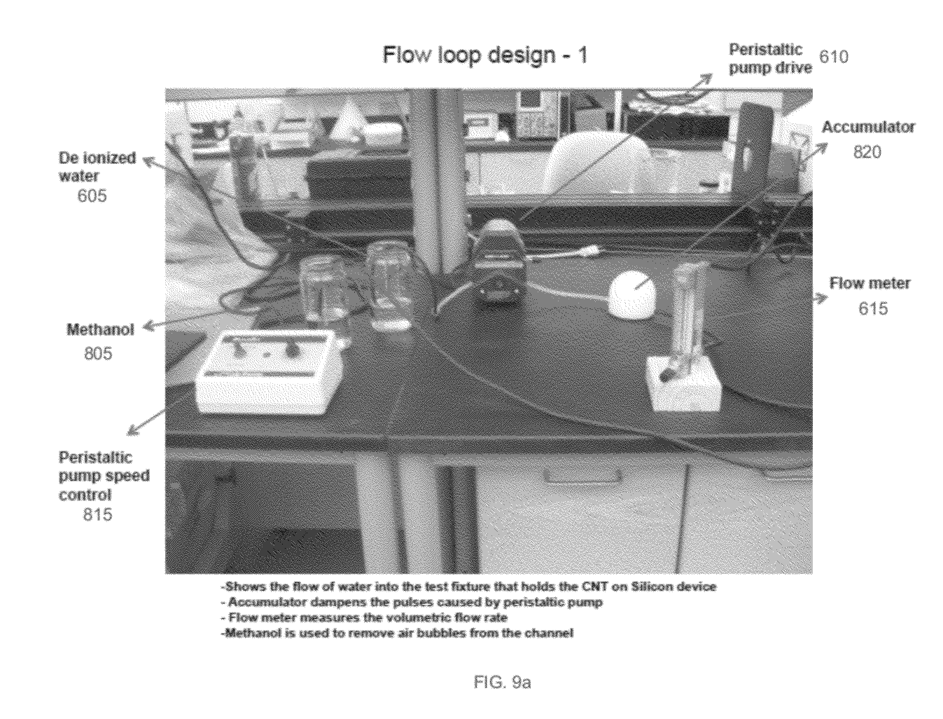

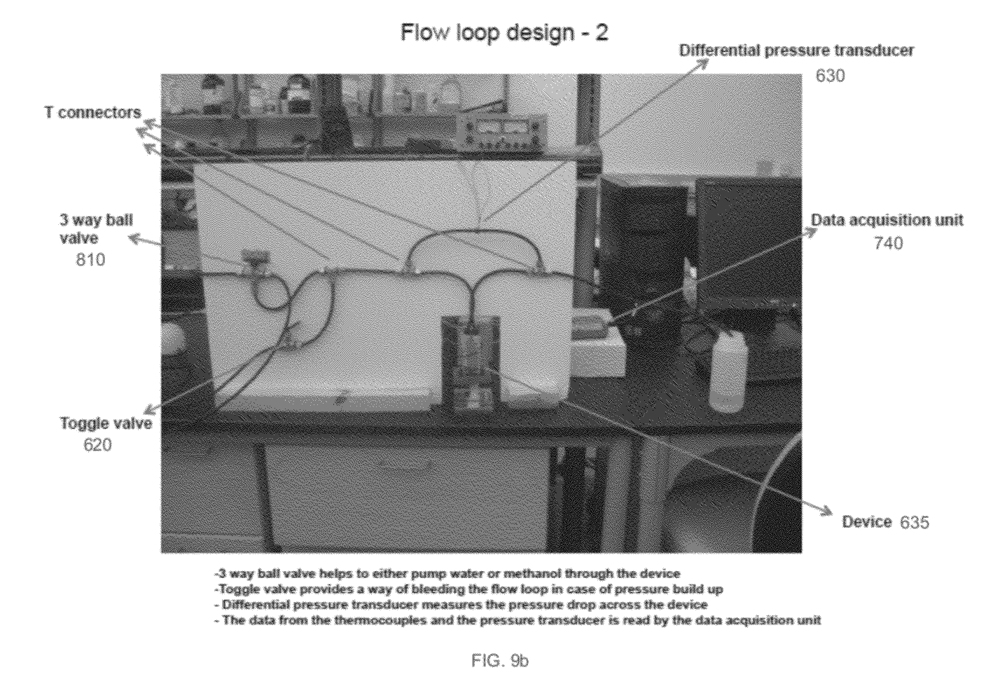

FIGS. 9a and 9b show a flow loop testing arrangement utilized for experimental testing. The flow loop testing arrangement provided water 605, pump 610, flow meter 615, toggle valve 620, pressure transducer 630, test fixture 635, and data acquisition unit 740. Methanol 805 is provided to remove air bubbles from the channel. Three way ball valve 810 allows water or methanol to be pumped through the system. Pump control 815 may be utilized to control the speed of pump 610. Accumulator 820 is utilized to dampen pulse caused by a peristaltic pump. Toggle valve 620 may be utilized to bleed the flow loop in case of pressure build up.

Data Reduction and Measurement Uncertainty

Uncertainties in measured quantities are 6% for the rotameter, 0.1° C. for the thermocouples and 7% for the pressure transducer. The heat loss was determined using computational modeling for the no MWNTs devices at different flow rates. The heat loss values obtained were then used to adjust the measured heat flux thus giving the heat flux applied to the base for the three different devices. The uncertainty associated with the heat flux applied to the base was calculated using the Kline and Mclintock method. The heat flux had an uncertainty range of 3.6-17%, the uncertainties being higher at lower heat fluxes.

Computational Modeling

The experimental setup is modeled using computation fluid dynamics software ANSYS CFX. This program meshes its geometry based on the finite volume method. In this technique, the region of focus is divided into small sub-regions known as control volumes. The equations are solved iteratively for each control volume. An approximation of the values solved by the equations can be obtained for each control volume. When combining the control volume, values can display the behavior of the whole region as an entity. The accuracy of the solution is proportional to the size and shape of the control volume and the side of the final residuals.

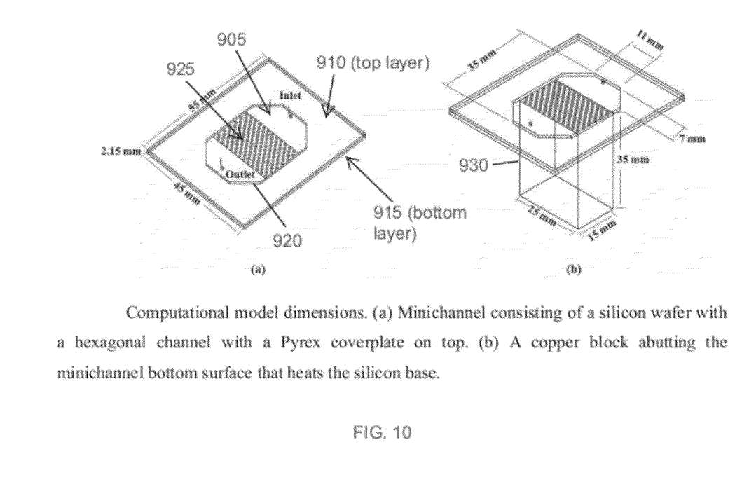

FIGS. 10a and 10b provide illustrative implementations of a computational model of a hexagonal mini channel and a copper block abutting the mini channel. To represent the mini channel 905, the model provided a rectangular silicon slab 910 under a rectangular glass slab 915. The silicon has dimensions of 45 mm×55 mm×2.15 mm (length×width×height). The silicon has a 1 mm deep octagonal groove 920 with the widest and longest part of the channel being 25 mm and 35 mm respectively. To enclose channel 905, a glass slab 915 of dimensions 45 mm×55 mm×1 mm is placed on the silicon. Two holes, 1 mm in diameter, are placed 12 mm away from the glass slab edge length on either side to create an inlet and outlet for the fluid to flow. Channel 905 may include an area 925 covered by a patterned array CNTs, fully covered by CNTs, or covered by no CNTs. Copper block 930 is added to the bottom surface of the silicon to match the geometry of the CNT array. It has dimensions 25 mm×15 mm×35 mm.

A constant heat flux ranging from 5-20 W/cm² is applied to the bottom surface of the copper block. The maximum value of heat flux used was curtailed by the fact that the software is more accurate in modeling the single-phase flows than two phase flows. Therefore, the experiments show results for higher heat fluxes than modeling. Water was used as the working fluid in the heat exchangers with volumetric flow rates ranging from of 40-80 ml/min. A no-slip boundary condition and no interfacial resistance were applied to each of the interfaces. Initial inlet temperature and outlet static pressure values were set for all simulations to be approximately 25° C. and 0 Pa, respectively. To monitor the thermal properties, the outer walls of the silicon and glass slabs and the copper block are assumed to be adiabatic. Similar to the experiment, the three device configurations—no MWNTs device, fully covered MWNTs device and 6×12 MWNT bundles devices—were simulated. In the case of the devices with MWNTs, even though in reality the MWNTs act as a nanostructured porous medium, the software was limited to considering them as a solid entity. A MWNT thermal conductivity of 400 W/m.K was used in all simulations.

Results

Pressure Drop Analysis

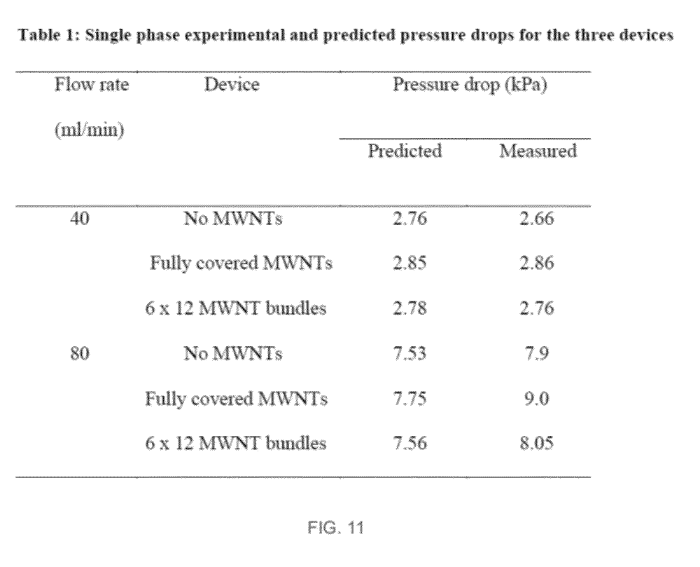

FIG. 11 shows the values of the measured pressure drop and the predicted measure drop for single phase in the three heat exchangers. The measured pressure drop measures not only the pressure drop across the channel, but also includes the pressure drop across the norprene tubing, the inlet and outlet manifolds and the pressure drop due to contraction and expansion as the water enters through different tubing sizes.

Therefore, the predicted pressure drop was determined by

ΔP=ΔPₘ+ΔPₙ+ΔP_{c}+ΔPₑ+ΔP_{ch} (2)

where ΔPₘ and ΔPₙ are the pressure drops across the manifolds and the norprene tubing. They are expressed as

$$\begin{matrix}Δ {P}_{m} = f \frac{L}{{D}_{hm}} \frac{ρ}{2} {u}_{m}^{2} \\ and & ( 3 ) \\ Δ {P}_{n} = f \frac{L}{{D}_{hn}} \frac{ρ}{2} {u}_{m}^{2} & ( 4 )\end{matrix}$$

where uₘ and uₙ are the fluid velocities in the manifold and norprene tubing and ρ is the density of water.

ΔP_{c} is the pressure drop due to contraction as the water flows from the larger norprene tubing into the inlet manifold tubing and ΔPₑ is the pressure drop due to expansion as the water flows from the outlet manifold into the norprene tubing. They are expressed as

$$\begin{matrix}Δ {P}_{c} = \frac{ρ}{2} ( {u}_{m}^{2} - {u}_{n}^{2} ) + \frac{{k}_{c} ρ {u}_{m}^{2}}{2} \\ and & ( 5 ) \\ Δ {P}_{e} = \frac{ρ}{2} ( {u}_{n}^{2} - {u}_{m}^{2} ) + \frac{{k}_{e} ρ {u}_{n}^{2}}{2} & ( 6 )\end{matrix}$$

The loss coefficients due to contraction (k_{c}) and expansion (kₑ) are taken as unity. ΔP_{ch} is the pressure drop across the mini channel and is determined through computational modeling. We observe that the predicted pressure drop values and the measured pressure drop values are in good agreement with each other. The difference in two values was found to be within the measurement uncertainty calculated for the pressure transducer. For both flow rates, the fully covered MWNTs device caused higher pressure drops when compared to the heat exchanger with no MWNTs and 6×12 MWNT bundles.

### Heat Transfer Analysis

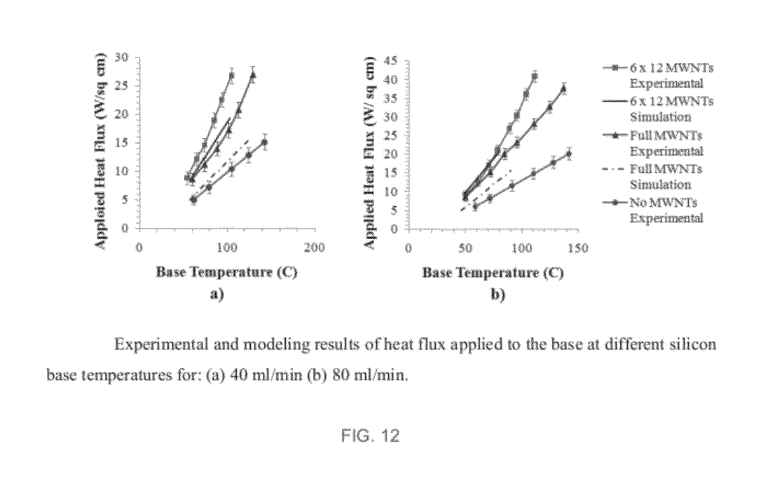

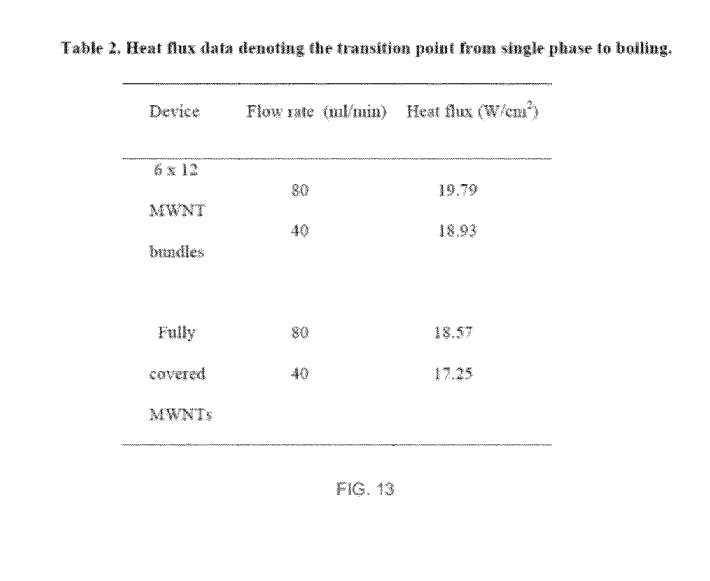

FIGS. 12a and 12b show the experimental and modeling results of the heat flux applied to the base versus the silicon base temperature for the three different devices. The computational fluid dynamics (CFD) modeling results for the heat exchanger with no MWNTs device are omitted since they have been used to calculate the heat loss values. The experimental results are an average plotted over 2 different runs for 40 ml/min and 80 ml/min volumetric flow rates. The plot shows the experimental results for both the single phase and boiling regimes. Since the modeling software was limited to single phase flows, the modeling results do not include the boiling regime. As clearly seen from the graphs, the devices with MWNTs perform much better than the device with no MWNTs in both regimes. It is seen that higher volumetric flow rates for each device results in higher heat transfer which means that a higher heat flux can be applied to the base while still keeping the silicon base temperature at a certain value. FIG. 13 shows the minimum heat fluxes for the different devices beyond which visible boiling starts to occur. For the 6×12 MWNT bundles device and the fully covered MWNTs device, surface area is much higher than the device with no MWNTs. Therefore, more heat is removed. The system takes longer to reach the saturation temperature providing a higher heat flux before nucleation. No visible boiling was observed in the case of no MWNTs device.

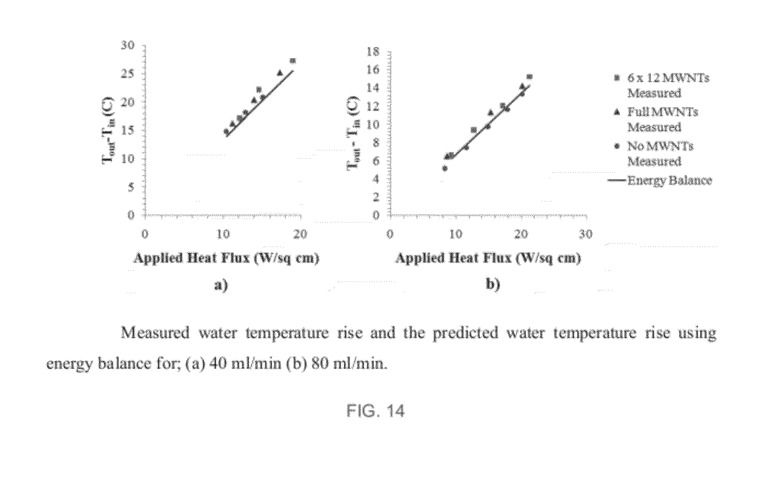

FIGS. 14a and 14b show the measured and predicted water temperature rise using the energy balance equation.

ρvcₚ(Tₒᵤₜ−Tᵢₙ)=Q (7)

Only heat flux ranges that keep the water in single phase were considered. For both 40 ml/min and 80 ml/min, the measured water temperature rise and the predicted water temperature rise are reasonably close proving the validity of our heat loss calculations. In the single phase regime, the devices with MWNTs perform much better. For a volumetric flow of 40 ml/min, one can apply only 6 W/cm² using no MWNTs device compared to 10 W/cm² using fully covered MWNTs device and 14 W/cm² using 6×12 MWNT bundles device while keeping the silicon base temperature at 70° C. Using 80 ml/min flow rate and the same base temperature, one can apply higher heat fluxes of 8 W/cm², 15 W/cm², 18 W/cm² using no MWNTs device, fully covered MWNTs device and 6×12 MWNT bundles device, respectively. For the fully covered MWNTs device, the decrease in hydraulic diameter, as seen from the increase in pressure drop, is the major factor for heat transfer enhancement. In the case of 6×12 MWNT bundles device, the enhancement could be due to a number of factors; predominantly it is due to the increase in surface area due to the bundles and also due to the decrease in hydraulic diameter as evident from the slight increase in the pressure drop. In addition to these factors, at higher temperatures there is significant wetting of the nanotubes by water that may have lead to increased heat transfer.

The difference between the modeling results and the experimental results for fully covered MWNTs device for both 40 ml/min and 80 ml/min is significant as evident through FIGS. 11a and 11b. The measured pressure drop and the predicted pressure drop are in agreement, therefore we cannot attribute this to the difference in hydraulic diameters. There need to be additional factors that cause the significant difference in the modeling and experimental results. One of the main reasons could be that the model considers the fully covered MWNTs area as a solid block, whereas in reality the fully covered MWNTs area has numerous hydrophilic MWNTs intertwined and entangled with nanoscale pores in between them allowing water to penetrate through the MWNTs. To illustrate further, the heat transfer coefficient obtained through modeling for 40 ml/min and 80 ml/min are 1649 W/m².K and 2327 W/m².K. Using the heat transfer coefficients, the corresponding surface area available for heat transfer in experiments can be found using Newton's law of cooling,

$$A = \frac{Q}{h ( {T}_{w} - {T}_{b} )} \qquad ( 8 )$$

where T_{w} is the base temperature, T_{b} is the bulk fluid temperature, Q is heat supplied to the base and h is the heat transfer coefficient. For 40 ml/min using an experimental heat flux of 13.9510 W/cm² and a bulk fluid temperature of 32.17° C., the surface area obtained was 36% higher than the modeling surface area and for 80 ml/min using an experimental heat flux of 15.32 W/cm² and a bulk fluid temperature of 27.21° C., the surface area obtained was 32% higher than the modeling surface area. This ties in well with the amount of water absorbed by the carbon nanotubes versus the fluid temperature reported. It is also clear that as the fluid temperature rises, there is increased wetting of the MWNTs which could lead to increased heat transfer. In the case of 6×12 MWNT bundles device the region occupied by MWNTs is much less than the fully covered MWNTs device thus any increase in wetting would not cause a substantial increase in heat transfer. Therefore, the modeling results and the experimental results for both 40 ml/min and 80 ml/min are in reasonable agreement.

An experimental study was conducted to determine the heat removal ability of MWNTs grown in a silicon mini channel with water as the cooling medium. It was observed that the presence of MWNTs resulted in enhanced heat removal from the silicon base. In the single phase regime, using a fully covered MWNTs device 1.6 times the heat flux to the silicon base compared to a no MWNTs device can be applied while still maintaining the same silicon base temperature. This increase had a drawback of the fully covered MWNTs device increasing the pressure drop by 7% for 40 ml/min and 14% for 80 ml/min. When using the 6×12 MWNT bundles device 2.3 times the silicon base heat flux compared to a no MWNTs device can be applied while maintaining the same silicon base temperature. The corresponding increase in pressure drop observed was 1.8% for 40 ml/min and 3.7% for 80 ml/min. It was also observed that at higher heat fluxes there is increased wetting of MWNTs by water resulting in enhanced heat removal. The increase in heat transfer may also be contributed to the motion of the individual nanotube. The MWNTs are intertwined within the structures with one end fixed to the silicon surface and the other side free. The unbounded end may act like a nanoscale cantilever beam, resonating with heat and enhancing heat removal because of the Brownian motion effect similar to the phenomena in nanofluids.

The computational modeling results differed from the experimental results with the experimental results showing higher heat removal than predicted by the model. This was true especially in the case of the full grown MWNTs device. One of the potential reasons attributed to this is due to the fact that the computational modeling considered the MWNTs as a solid medium whereas in reality the MWNTs are a nanostructured porous medium. The optimization of the micro-fin size, shape, and spacing also has an effect on the removal of heat from the surface. Many parameters affect the heat transfer performance of fins especially its geometry, fluid flow rate, and material properties.

In some implementations, it may be desirable to use dielectric fluids as the working fluid. Dielectric fluids may perform better than water due to their increased wettability of MWNTs. The low boiling point of dielectric fluids however necessitates consideration of two-phase flows when modeling. Additionally, penetration of different fluids into MWNTs at different temperatures should also be considered when determining optimal flow characteristics and the design of devices with MWNTs.

Analysis of these systems using the Lattice Boltzmann Method may provide further information. Unlike CFD software such as ANSYS CFX, the Lattice Boltzmann Method is based on microscopic models and mesoscopic kinetic equations. This method can include finer details needed at the micro- or meso-scales such as the surface tension effects and the porosity of MWNTs.

The following was observed from the above-mentioned experiments: (1) the fully covered carbon nanotubes device was able to remove 22% higher heat rate than the heat rate removed by the device with no carbon nanotubes; and (2) the heat rate removed by the device with carbon nanotubes pin fins was 26% higher than the heat rate removed by the fully covered carbon nanotubes device.

The results suggest that the heat exchangers with surfaces covered by CNTs resulted in significantly enhanced heat removal. This is contrary to the findings prior attempts to utilize CNTs in micro channels of heat exchangers, where it was concluded that the CNTs in the silicon micro channels they tested resulted in the CNTs hindering the heat rate removal. This result was attributed to the hydrophobic nature of the CNTs and the clumping of CNTs due to drying. Further, experiments using air cooling have also been also unsuccessful. However, in the experiments discussed herein, it was observed that the CNTs were hydrophobic at lower temperatures but turned hydrophilic at higher temperatures. This resulted in increased heat removal as observed in the case of fully covered carbon nanotubes device.

The silicon channel with CNT pin fins has the added advantage of increased surface area available for heat removal due to the fin architecture resulting in even more enhanced heat removal.

In sum, in some implementations, the silicon/copper/aluminum mini or micro channels with MWNTs may be used in the cooling of electronics and other devices. These MWNTs can be grown on a different substrate and used to produce improved heat exchangers.

Without further elaboration, it is believed that one skilled in the art can, using the description herein, utilize the present invention to its fullest extent. The implementations described herein are to be construed as illustrative and not as constraining the remainder of the disclosure in any way whatsoever. While the preferred implementations have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is the following:

1. A heat exchanger comprising:
a heat spreader providing at least one channel;
a cover plate secured to the heat spreader, wherein the cover plate encloses the channel; and
a plurality of vertically aligned nanostructures disposed on at least one channel surface.

2. The apparatus of claim 1, wherein nanostructures are single-walled carbon nanotubes or multi-walled carbon nanotubes.

3. The apparatus of claim 1, wherein a predetermined area on the at least one channel surface of the heat spreader is fully covered by the nano structures.

4. The apparatus of claim 1, wherein the nanostructures are arranged into bundles on the channel surface of the heat spreader.

5. The apparatus of claim 4, wherein the bundles are circular, square, rectangular, or oval shaped.

6. The apparatus of claim 4, wherein a working fluid that flows through the channel is water, a nanofluid, or a dielectric fluid.

7. The apparatus of claim 1, wherein the channel is a micro channel or mini channel.

8. The apparatus of claim 1, wherein the channel has a hydraulic diameter between 3 mm to 200 micrometers.

9. The apparatus of claim 1, wherein the heat spreader is made of silicon, aluminum, or copper.

10. The apparatus of claim 1, wherein a working fluid that flows through the channel is water, a nanofluid, or a dielectric fluid.

11. A heat exchanger comprising:
a heat spreader providing a plurality of fins, wherein the fins dissipate heat absorbed by the heat spreader;
a cover plate secured to the heat spreader, wherein the fins and cover plate define at least one channel provided for fluid flow; and
a plurality of vertically aligned carbon nanotubes disposed on at least one channel surface.

12. The apparatus of claim 11, wherein a predetermined area on the at least one channel surface of the heat spreader is fully covered by the carbon nanotubes.

13. The apparatus of claim 11, wherein the carbon nanotubes are arranged into bundles on the channel surface of the heat spreader.

14. The apparatus of claim 13, wherein the bundles are circular, square, rectangular, or oval shaped.

15. The apparatus of claim 11, wherein the heat spreader is made of silicon, aluminum, or copper.

16. The apparatus of claim 11, wherein said at least one channel is a micro channel or a mini channel.

17. The apparatus of claim 11, wherein the channel has a hydraulic diameter between 3 mm to 200 micrometers.

18. The apparatus of claim 11, wherein geometries of the plurality of fins of the heat spreader are cylindrical, one-edge slanted, two-edge slanted, roof top, or conical.

19. The apparatus of claim 11, wherein a working fluid that flows through the channel is water, a nanofluid, or a dielectric fluid.

20. A method for fabricating a heat exchanger, the method comprising:
forming a plurality of nanostructures on a substrate, wherein the plurality of nanostructures are vertically aligned on the substrate;
forming one or more openings in a channel layer;
securing the channel layer to the substrate, wherein the openings in the channel layer are aligned with the nanostructures on the substrate; and
securing a top layer to the channel layer, wherein the top layer, channel layer, and substrate define at least one channel containing the nanostructures.

21. The method of claim 20, wherein nanostructures are single-walled carbon nanotubes or multi-walled carbon nanotubes.

22. The method of claim 20, wherein said one or more openings in the channel layer are formed by laser cutting.

23. The method of claim 20, further comprising removing some of the nanostructures from the substrate to form one or more patterned bundles.

24. The method of claim 23, wherein the bundles are circular, square, rectangular, or oval shaped.

25. The method of claim 23, wherein the nanostructures are removed by laser cutting.

26. The method of claim 20, wherein the at least one channel is a micro channel or a mini channel.

27. The method of claim 20, wherein the channel has a hydraulic diameter between 3 mm to 200 micrometers.

28. The method of claim 20, wherein the substrate is made of silicon, aluminum, or copper.

29. A method for exchanging heat with a heat exchanger comprising:
positioning a heat exchanger on an electronic device, the heat exchanger comprising
a heat spreader providing at least one channel,
a cover plate secured to the heat spreader, wherein the cover plate encloses the channel, and
a plurality of vertically aligned nanostructures disposed on at least one channel surface; and
inputting a fluid into said at least one channel of the heat exchanger through an inlet, wherein the fluid remains in a liquid phase when passing through the channel.

30. The method of claim 29, wherein nanostructures of the heat exchanger are single-walled carbon nanotubes or multi-walled carbon nanotubes.

31. The method of claim 29, wherein a predetermined area on the at least one channel surface of the heat spreader is fully covered by the nanostructures.

32. The method of claim 29, wherein the nanostructures are arranged into bundles on the channel surface of the heat spreader.

33. The method of claim 32, wherein the bundles are circular, square, rectangular, or oval shaped.

34. The method of claim 29, wherein the channel of the heat exchanger is a micro channel or mini channel.

35. The method of claim 29, wherein the channel of the heat exchanger has a hydraulic diameter between 3 mm to 200 micrometers.

36. The method of claim 29, wherein the heat spreader of the heat exchanger is made of silicon, aluminum, or copper.

37. The method of claim 29, wherein the fluid inputted into the channel of the heat exchanger is water, a nanofluid, or a dielectric fluid.
